(19) United States
(12) Patent Application Publication
(10) Pub. No.: US 2015/0072719 A1
(43) Pub. Date: Mar. 12, 2015

(54) MOBILE TERMINAL, WIRELESS COMMUNICATION SYSTEM AND WIRELESS COMMUNICATION METHOD

(71) Applicant: KYOCERA CORPORATION, Tokyo (JP)

(72) Inventors: Jun Kano, Kanagawa (JP); Minako Kitahara, Kanagawa (JP)

(73) Assignee: KYOCERA CORPORATION, Kyoto (JP)

(21) Appl. No.: 14/364,782

(22) PCT Filed: Dec. 13, 2012
(86) PCT No.: PCT/JP2012/082368

§ 371 Date: Jun. 12, 2014

(30) Foreign Application Priority Data
Dec. 13, 2011 (JP) 2011-271917
Dec. 13, 2011 (JP) 2011-271918

(51) Int. Cl. H04B 7/06; H04W 52/04

(52) U.S. Cl. CPC H04B 7/0619; H04W 52/04
USPC 455/522

(57) ABSTRACT

Provided is a mobile terminal, which transmits feedback signals when performing transmission power control with a base station. The mobile terminal is provided with: a plurality of antennas; a calculation unit, which obtains reception qualities based on known signals and signals received from at least one of the antennas; and a feedback information determining unit, which determines feedback information based on the reception qualities. The mobile terminal transmits feedback signals based on the feedback information to the base station.

### TECHNICAL FIELD

The invention relates to a mobile terminal, a wireless communication system and a wireless communication method, which are performing transmission power control.

### BACKGROUND ART

### Adaptive Antenna Array

An adaptive antenna array having a plurality of antenna devices is typically implemented in a base station. When the antenna array is implemented in the base station, it is possible to suppress an interference wave included in an uplink reception wave, and to estimate an incoming path of a desired wave by deriving an antenna weight that is obtained by reception.

Also, the adaptive antenna array sets a transmission antenna weight for a wireless terminal to be estimated so that an SINR becomes a maximum and a signal is suppressed in the other cases. Thereby, since it is possible to secure a communication quality and to considerably increase a link capacity, the research has been actively made in recent years. As an actually operating example, there is an iBurst system based on “High Capacity-Spatial Division Multiple Access (HC-SDMA) WTSC-2005-032 (ATIS/ANSI)”.

(TDMA-TDD & Antenna Array)

In particular, according to a TDMA-TDD method, since a channel of an uplink direction from a wireless terminal to a base station and a channel of a downlink direction from the base station to the wireless terminal use the same frequency, it is possible to theoretically use the antenna weight, which is obtained by reception, for transmission. Thus, it is possible to easily improve the performance of the antenna array method. That is, according to the antenna array of the TDMA-TDD method, it is assumed that the same frequency band for a short time period is continuity in a communication pathway and a propagation characteristic on a propagation pathway between an arbitrary point and another arbitrary point, and that an antenna overlap coefficient, which is matched with the communication pathway obtained by reception of an uplink, is used for downlink transmission. In general, the assumption has a sufficient usefulness when an interval between a received signal and a transmission signal to be used for estimation is short and a moving speed of the wireless terminal is slow.

(Acquisition Method of Antenna Weight)

As a simple method of deriving a weight for each antenna from received signals of a plurality of antennas, a maximum ratio combining (MRC) method has been known. The MRC method matches phases of signals that are received at respective branches of the antennas, derives weights for each antenna depending on levels of the respective received signals, and combines the respective received signals in accordance with the weights for each antenna. Since a complex calculation is not required and improvement on an S/N ratio can be somewhat expected, the MRC method is frequently used.

Also, a variety of methods for improving the S/N ratio in the received signal have been devised. For example, as a method of obtaining an antenna weight more precisely, a method of using a Winner solution has been known. In particular, as a method of obtaining the Winner solution, a sequential update method using an adaptive algorithm (MMSE method) minimizing a mean square error (MSE) between a training signal (reference signal) and signals received from the reception antenna array has been known. As the adaptive algorithm, a least mean square (LMS) algorithm is frequently used. According to the MMSE method, only a small diversity gain can be obtained when the number of reception antennas is small. However, the MMSE method is frequently used because it is possible to reduce arithmetic processing.

As a method having higher throughput than the MMSE method, a successive interface canceller (SIC) method, a maximum likelihood detection (MLD) method and the like have been devised and actually used. However, these methods require more arithmetic processing than the MMSE method, so that a high-speed arithmetic device is required.

(Adaptive Antenna Array in Terminal)

The above method of acquiring the antenna weight and combining the signals received from the respective antennas to thus improve the S/N ratio can be also applied to a mobile terminal. That is, a plurality of antennas that is used for reception is provided for the mobile terminal, antenna weights are acquired from the signals received from the respective antennas and the received signals are combined. According to this method, it is possible to expect that the received signals having an improved S/N ratio, as compared to a configuration where only one antenna is used to receive a signal.

In order to derive the weights of the respective antennas by the LMS algorithm and the like, a method of giving a known training signal to a received signal has been known. According to this method, a transmission side gives a known training signal pattern, which is shared by the base station and the mobile terminal, to a head or end or both the head and end of a transmission signal and a reception side uses the known pattern as the training signal.

(Transmission Power Control of Base Station Based on Feedback Information from Terminal)

In general, a signal level that is received by a receiver depends on a signal transmission level that is transmitted by a transmitter, a property of a propagation pathway, a distance to the transmitter and the like. As the transmission power is stronger on condition that the other conditions are the same and the received signal is not saturated, the signal S/N ratio of the received signal is better. In the meantime, since the strong signal influences a neighboring frequency band, it is necessary to make consideration so that the transmission signal is not stronger than necessary. In particularly, when an OFDM method is adopted, since a sub-carrier exists at a close frequency, delicate power control is required (refer to Patent Document 1 about the transmission power control).

As the method of the transmission power control, a method of controlling transmission power that is necessary and sufficient for a communication opponent by feedback of reception quality information of an opponent communication apparatus has been known. In the base station, the transmission power control is generally performed as a part of a scheduling of allocating channels to a plurality of mobile terminals by a set of a frequency and time. The scheduling method for the multiple mobile terminals, considering a mutual influence with a neighboring frequency channel, may be a ‘a ratio of a maximum carrier wave to an interference wave’ type or a ‘proportional fairness’ type.

### CITATION LIST

### Patent Literature

[PTL 1] JP-A-2011-135473

### SUMMARY OF THE INVENTION

### Problems to be Solved

Up to now, a challenge of applying an advanced adaptive antenna array reception method to a mobile terminal has not been studied.

The invention has been made in light of the above situation, and an object of the invention is to provide a mobile terminal, a wireless communication system and a wireless communication method performing appropriate transmission power control.

### Solution to Problems

A mobile terminal of the invention transmits a feedback signal when performing transmission power control with a base station. The mobile terminal includes a plurality of antennas, a calculation unit that calculates a reception quality based on a known signal and a signal received from at least one of the multiple antennas, and a feedback information determining unit that determines feedback information based on the reception quality. The mobile terminal transmits a feedback signal based on the feedback information to the base station.

Also, according to the mobile terminal of the invention, the calculation unit may obtain the reception quality, based on the known signal and a synthesized signal obtained by an antenna array reception method of the respective signals received from the multiple antennas, and the feedback information determining unit may determine the feedback information, based on the reception quality and an offset value.

Also, according to the mobile terminal of the invention, the calculation unit may obtain the reception quality, based on the one received signal of the multiple antennas and the known signal.

A mobile terminal of the invention transmits a feedback signal when performing transmission power control with a base station. The mobile terminal includes a storage unit that stores a instruction set, and a controller. The controller executes the instruction set, calculates a reception quality based on a known signal and a signal received from at least one of the multiple antennas, determine feedback information based on the reception quality, and transmit a feedback signal based on the feedback information to the base station.

A wireless communication method of the invention is a wireless communication method of a mobile terminal that transmits a feedback signal when performing transmission power control with a base station. The wireless communication method includes the steps of obtaining a reception quality based on a known signal and a signal received from at least one of a plurality of antennas, determining feedback information based on the reception quality, and transmitting a feedback signal based on the feedback information to the base station.

In the meantime, the invention may be configured as a wireless communication system.

### Advantageous Effects of the Invention

The mobile terminal, the wireless communication system and the wireless communication method of the invention can perform appropriate transmission power control.

### BRIEF DESCRIPTION OF THE DRAWINGS

FIG. 1 is a configuration view of a wireless communication system according to an illustrative embodiment of the invention.

FIG. 2 is a configuration view of a communication frame of a TDD-OFDMA method.

FIG. 3 is a block diagram of a mobile terminal according to an illustrative embodiment of the invention.

FIG. 4 is a configuration view of a base station according to an illustrative embodiment of the invention.

FIG. 5 is a configuration view of a communication unit of a mobile terminal (three antennas) according to a first illustrative embodiment of the invention.

FIG. 6 is a configuration view of a mobile terminal (one antenna) according to an illustrative embodiment of the invention.

FIG. 7 shows a part of an operation of a wireless communication system according to the first illustrative embodiment of the invention.

FIG. 8 is a configuration view of a communication unit of a mobile terminal (three antennas) according to a second illustrative embodiment of the invention.

FIG. 9 shows a part of an operation of a wireless communication system according to the second illustrative embodiment of the invention.

FIG. 10 is a configuration view of a communication unit of a mobile terminal (three antennas) according to a third illustrative embodiment of the invention.

FIG. 11 shows a part of an operation of a wireless communication system according to the third illustrative embodiment of the invention.

### DESCRIPTION OF ILLUSTRATIVE EMBODIMENTS

Hereinafter, illustrative embodiments of the invention will be described with reference to the drawings.

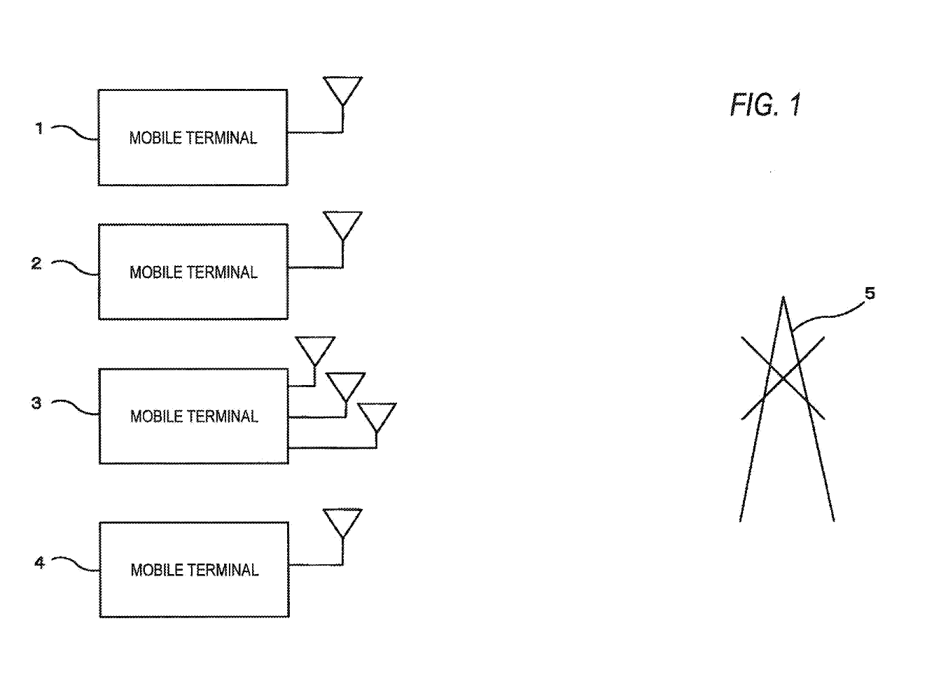

FIG. 1 is a configuration view of a wireless communication system according to an illustrative embodiment of the invention. As shown in FIG. 1, the wireless communication system consists of mobile terminals 1 to 4 and a base station 5. In order to simplify the descriptions, it is assumed that the base station 5 has one antenna. The mobile terminal 1, the mobile terminal 2 and the mobile terminal 4 use one antenna for transmission and reception, and the mobile terminal 3 uses three antennas for reception and uses one antenna for transmission.

It is assumed that the wireless communication system performs wireless communication by a TDD-OFDMA method of dividing a period into an uplink period and a downlink period and adopting a time division multiplexing. Also, it is assumed that a communication method, which is used for downlink between the base station 5 and the mobile terminals 1 to 4, has four sub-carriers.

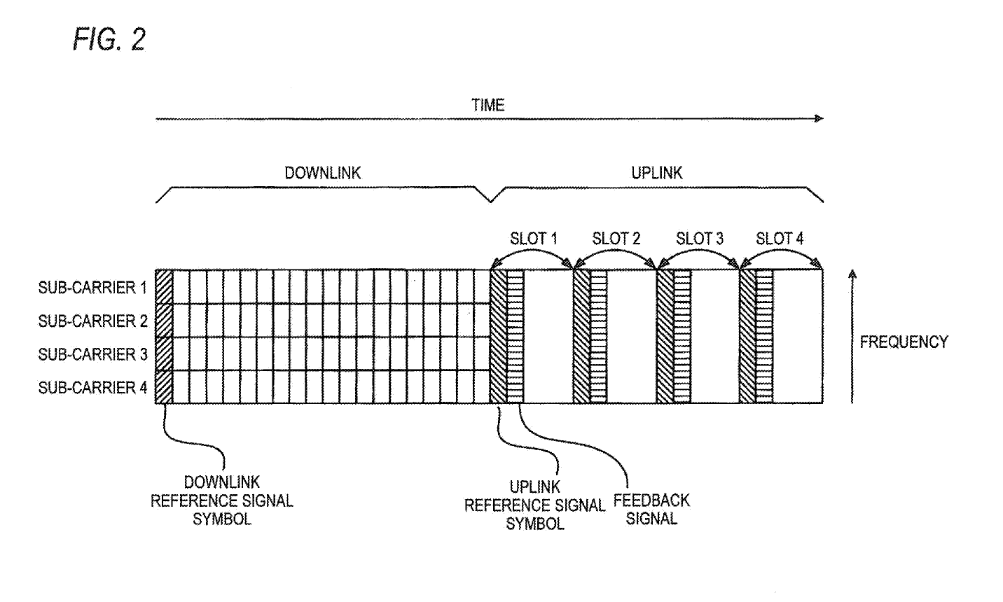

FIG. 2 is a configuration view of a communication frame of the TDD-OFDMA method.

A downlink 20 is divided into twenty sub-frames. Also, a reference signal symbol is positioned at a sub-frame that is positioned at a head of a downlink period. A reception side already knows a signal stream of the symbols. A symbol rather than the reference signal symbol is an information symbol, and the information symbol can transport arbitrary information.

A communication method that is used for uplink has four time slots. A reference signal symbol is positioned at a head portion of each slot and the reception side already knows a signal stream of the symbols. A symbol except for the reference signal symbol is an information symbol, and the information symbol can transport arbitrary information.

In order to simplify the descriptions, it is premised that each sub-carrier and each slot are used for communication between the predetermined mobile terminal and the base station, and it is assumed that the sub-carrier 1/the slot 1 are allocated to the mobile terminal 1, the sub-carrier 2/the slot 2 are allocated to the mobile terminal 2, the sub-carrier 3/the slot 3 are allocated to the mobile terminal 3 and the sub-carrier 4/the slot 4 are allocated to the mobile terminal 4.

When performing transmission from the base station 5 to any mobile terminal, a downlink reference signal that is shared with the mobile terminal is carried on a first sub-frame and arbitrary information is carried on a subsequent sub-frame, so that a transmission signal is prepared for each sub-carrier. This operation is repeated in correspondence to the number of the sub-carriers. After the transmission signals of all the sub-carriers are obtained, the transmission signals are IFFT-converted and RF-modulated, which are then transmitted through the antenna.

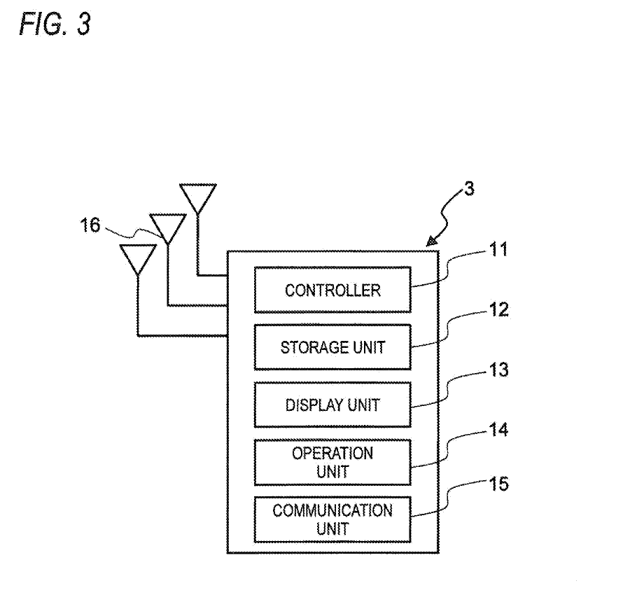

FIG. 3 is a block diagram of the mobile terminal according to an illustrative embodiment of the invention. The mobile terminal 3 has a controller 11, a storage unit 12, a display unit 13, an operation unit 14, a communication unit 15 and antennas 16. The controller 11 consists of a CPU, for example, processes signals received from the antennas 16 based on a program having a instruction set stored in the storage unit 12 and functions as various constitutional elements, which will be described later. Also, the controller 11 receives a user input from the operation unit 14 and controls display of the display unit 13. The communication unit 15 will be described later. Meanwhile, in FIG. 3, the mobile terminal 3 is exemplarily shown. However, the other mobile terminals also have the same configuration, except for the antenna.

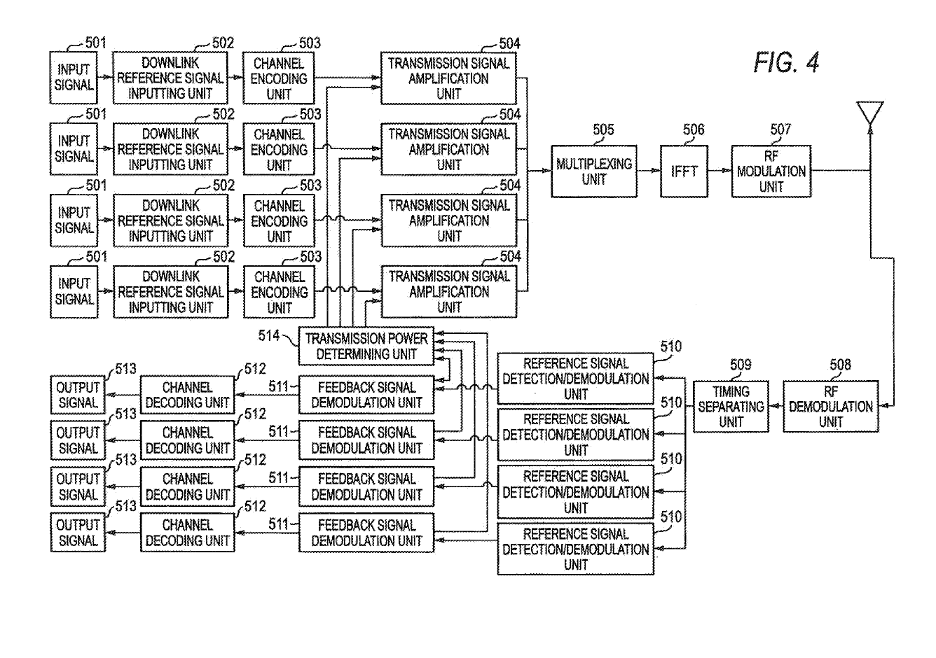

FIG. 4 is a configuration view of a base station according to an illustrative embodiment of the invention.

Each downlink reference signal inputting unit 502 is input with an input signal 501 corresponding to the sub-carrier (for each mobile terminal). Each downlink reference signal inputting unit 502 inputs a downlink reference signal so that it is carried on a first sub-carrier.

Each channel encoding unit 503 encodes the signal of each sub-carrier, and each transmission signal amplification unit 504 amplifies the signal of each sub-carrier, in accordance with transmission power determined in a transmission power determining unit 514.

A multiplexing unit 505 multiplexes the amplified signals of the sub-carriers, an IFFT 506 inverse Fourier transforms the multiplexed transmission signal, and an RF modulation unit 507 RF modulates the inverse Fourier transformed transmission signal and transmits the same through the antenna.

An RF demodulation unit 508 performs RF-demodulation on a received signal, a timing separating unit 509 extracts a signal, which is separated from the demodulated received signal at timing every slot, and each feedback signal demodulation unit 511 demodulates each feedback signal from each slot. Each channel decoding unit 512 decodes the signal of each slot as an output signal 513.

### First Illustrative Embodiment of the Invention

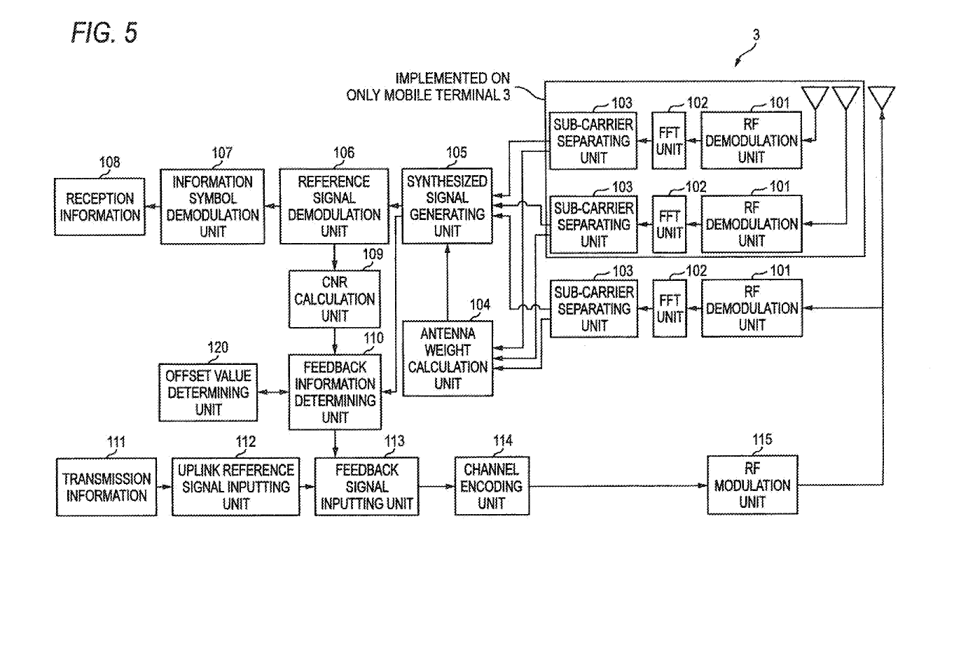

Hereinafter, a first illustrative embodiment of the invention is described. FIG. 5 is a configuration view of a communication unit of a mobile terminal (three antennas) according to a first illustrative embodiment of the invention. In the meantime, the mobile terminal 3 adopts a beam forming multi-antenna reception manner using the MMSE method.

Each RF demodulation unit 101 performs RF-demodulation on a signal received at each antenna, each FFT unit 102 FFT-transforms the RF-demodulated received signal and each sub-carrier separating unit 103 separates the received signal of sub-carrier.

An antenna weight calculation unit 104 calculates an antenna weight for each antenna by using the MMSE method, for example, based on the received signal of sub-carrier of each sub-carrier separating unit 103. A synthesized signal generating unit 105 generates a synthesized signal from the received signals of sub-carriers, based on the received signal of sub-carrier of each sub-carrier separating unit 103 and the antenna weight for each antenna.

A reference signal demodulation unit 106 demodulates a downlink reference signal from the synthesized signal, and an information symbol demodulation unit 107 demodulates an information symbol from the synthesized signal. The demodulated symbol becomes reception information 108.

A CNR calculation unit 109 compares the downlink reference signal and a known signal to thus obtain a CNR (Carrier to Noise Ratio) as a value of the S/N ratio. In the meantime, the downlink reference signal is also used for frame synchronization of the base station 5 and the mobile terminal.

A feedback information determining unit 110 determines reception quality information to be carried on a feedback signal, as an offset value corresponding to the CNR. Specifically, a value that is lower than the CNR value by the offset value is set as the reception quality information. In the meantime, an offset value determining unit 120 will be described later.

An uplink reference signal inputting unit 112 inputs a known signal as the reference signal to transmission information 111. A feedback signal inputting unit 113 inputs the CNR, which is obtained in previous reception, as the reception quality information to be carried on a feedback signal.

A channel encoding unit 114 encodes the feedback signal and the information symbol, and an RF modulation unit 115 performs RF-modulation on the encoded transmission signal and transmits the same at timing of prescribed time slot through the antenna.

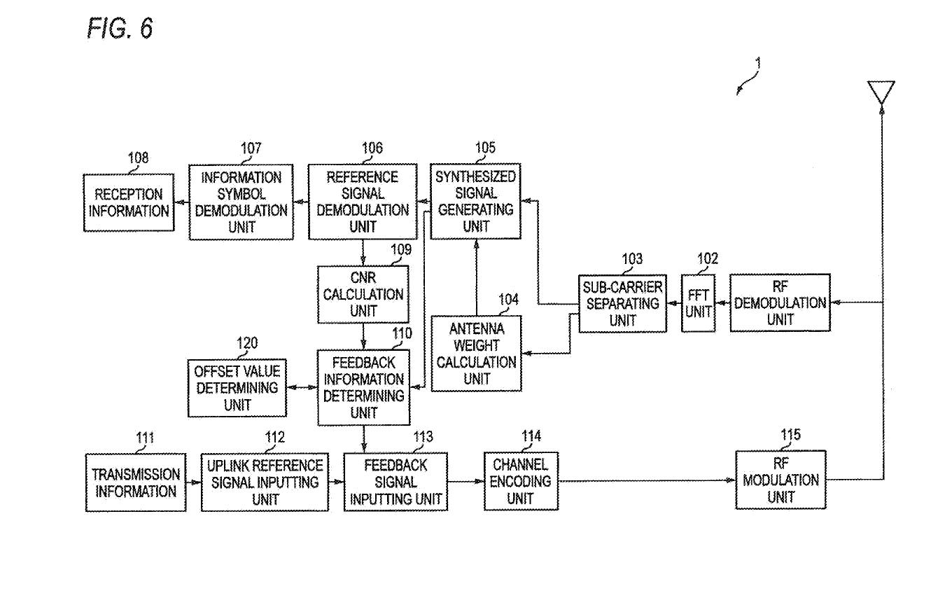

FIG. 6 is a configuration view of a mobile terminal (one antenna) according to an illustrative embodiment of the invention.

The mobile terminal 1 of FIG. 6 is the same as the mobile terminal 2 and the mobile terminal 4. A difference to the mobile terminal 3 is the number of antennas. Since the mobile terminal 1, the mobile terminal 2 and the mobile terminal 4 have only one antenna, the feedback information determining unit 110 makes the offset value zero. Therefore, a value that is output from the feedback information determining unit 110 coincides with the CNR value of the synthesized signal.

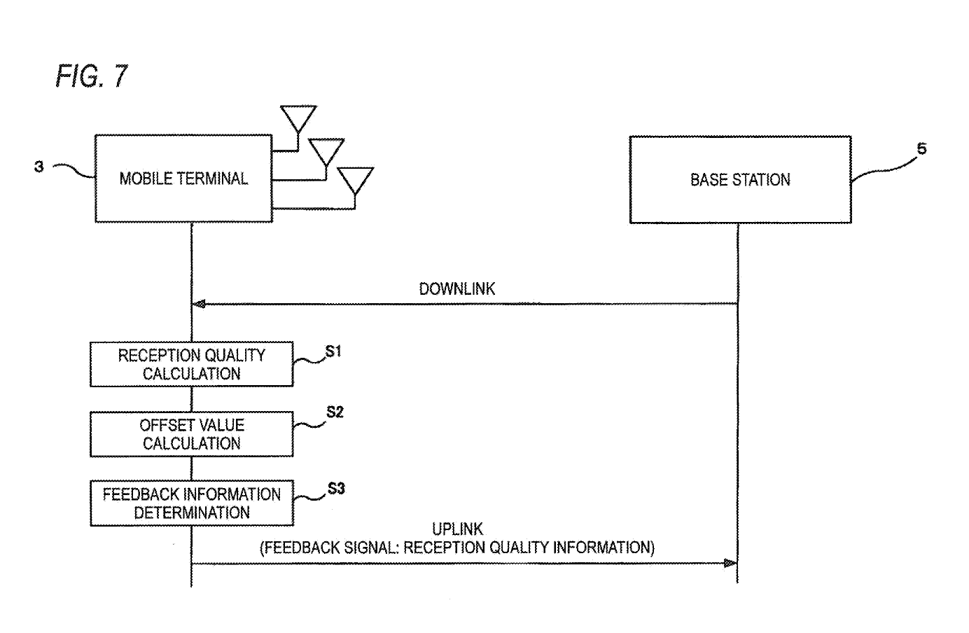

FIG. 7 shows a part of an operation of a wireless communication system according to the first illustrative embodiment of the invention.

The mobile terminal 3 receives a signal (downlink) transmitted from the base station 5, and obtains reception qualities based on known signals and synthesized signals obtained from the signals received from the antennas by the antenna array reception method (S1).

Since the mobile terminal 3 has the three antennas, the feedback information determining unit 110 of the mobile terminal 3 determines a gain, which is expected to be obtained by the MMSE method, as an offset value (S2).

The feedback information determining unit 110 outputs a value, which is lower than the calculated CNR value by the offset value, as reception quality information (feedback information) to be carried on a feedback signal (S3).

The transmission power determining unit 514 of the base station 5 compares the reception quality information included in the four feedback signals corresponding to each time slot, and determines a transmission signal level for next sub-carrier. At this time, the transmission power determining unit 514 controls so that the transmission level is lowered when the reception quality is better than the others and the transmission level is increased if the level does not reach an upper limit, when the reception quality is poorer, thereby adjusting an overall balance.

Here, for example, regarding the mobile terminal of the related art, it is assumed that a mobile terminal A uses the maximum ratio combining method, a mobile terminal B adopts a reception apparatus using a maximum likelihood detection method and the mobile terminal A, the mobile terminal B and the base station perform communication by performing transmission power control. In this case, it is assumed that the mobile terminal B can obtain a synthesized received signal having a higher receiving S/N ratio by 3 dB than the mobile terminal A.

Both the mobile terminal A and the mobile terminal B feeds back the S/N ratio information to the base station, as the reception quality information. The base station compares the reception quality information transmitted from the mobile terminal A and the mobile terminal B. However, since the base station does not determine a difference of reception performance of the two mobile terminals, the base station determines that the transmission signal to the mobile terminal B is unnecessarily higher, as compared to the transmission signal to the mobile terminal A. As a result, the base station performs control so that the transmission power to the mobile terminal B is lowered.

As a result, the S/N of the received signal that is synthesized by the mobile terminal B is deteriorated to the same level as the S/N of the received signal of the mobile terminal A. Like this, the mobile terminal B having improved the reception performance with a great deal of money can obtain only the same reception performance as the mobile terminal A having compromised with the reception performance without a great deal of money.

Furthermore, in general, the tolerance of the receiver to the fading is more stable in many cases when a signal level is higher at an antenna end. Therefore, when the moving is accompanied under multipath circumstances, the mobile terminal B is controlled by the base station so that the weaker reception electric wave is made. Therefore, a case where the mobile terminal B is in a more disadvantageous position than the mobile terminal A occurs.

That is, even when the advanced adaptive antenna array is applied to the mobile terminal by using a plurality of antennas, the base station reduces the transmission power of the mobile terminal by the transmission power control, so that the reception quality of the base station may be lowered as the S/N ratio improved by the adaptive antenna array reception method.

In contrast, according to the first illustrative embodiment of the invention, the base station 5 does not suppress the transmission power so that it is low in conformity to the feedback signal from the mobile terminal 3 conformed to the improved portion of the reception performance. Therefore, the mobile terminal 3 can exhibit the performance in conformity to the reception performance.

By the way, in the mobile terminal 3, when the CNR value is somewhat large, if it is reported that the reception quality information, which is fed back to the base station 5, is as low as the improved portion of the reception performance, it is possible to secure the improved portion of the reception performance as a margin because there is no case where the transmission power of the base station 5 becomes low beyond expectation. However, as the CNR value is lowered, if it is reported that the reception quality information, which is fed back to the base station 5, is as low as the improved portion of the reception performance, the base station 5 determines that the communication is impossible, which cannot contribute to the increase in coverage.

Accordingly, the offset value determining unit 120 prepares various levels of offset values in correspondence to the CNR value. When the CNR value is large, the offset value determining unit sets the offset value to be large, when the CNR value is small, the offset value determining unit sets the offset value to be small, and when the CNR value is more smaller, the offset value determining unit sets the offset value to be zero. Thereby, when the CNR value is large, the offset value determining unit allocates the improved portion of the reception performance to the reception margin.

When the CNR value is small, the reception quality information based on the reception performance is fed back to the base station 5. Thereby, even when the mobile terminal is far away from the base station 5, it is possible to increase the coverage by the improved portion of the reception performance.

In the above example, the mobile terminal 1, the mobile terminal 2 and the mobile terminal 4 has one antenna, and the mobile terminal 3 adopts the beam forming multi-antenna reception manner using the MMSE method. However, the invention can be also applied to a configuration where the mobile terminal 1, the mobile terminal 2 and the mobile terminal 4 adopt the beam forming multi-antenna reception manner and the other beam forming method such as the maximum ratio combining method, the MMSE method, the SIC method, the MLD method and the like is adopted.

That is, the offset value determining unit 120 for each CNR can secure the reception margin coverage conformed to the improvement of the reception performance by changing the offset value in conformity to an expected degree of the reception performance improvement for each beam forming multi-antenna reception manner.

### Second Illustrative Embodiment of the Invention

In the first illustrative embodiment of the invention, the example has been described in which the base station lowers the transmission power of the mobile terminal by the transmission power control, depending on the difference of the reception method, so that the reception quality of the base station is lowered as the S/N ratio improved by the adaptive antenna array reception method. However, the same situation may be caused, depending on the difference of the number of the antennas.

In the below, a second illustrative embodiment of the invention is described. Also in the second illustrative embodiment, since the communication method and the configurations of the base station and the mobile terminal (one antenna) are the same as those of the first illustrative embodiment, the overlapping descriptions are omitted. Also, the configurations having the functions equivalent to the first illustrative embodiment are denoted with the same reference numerals.

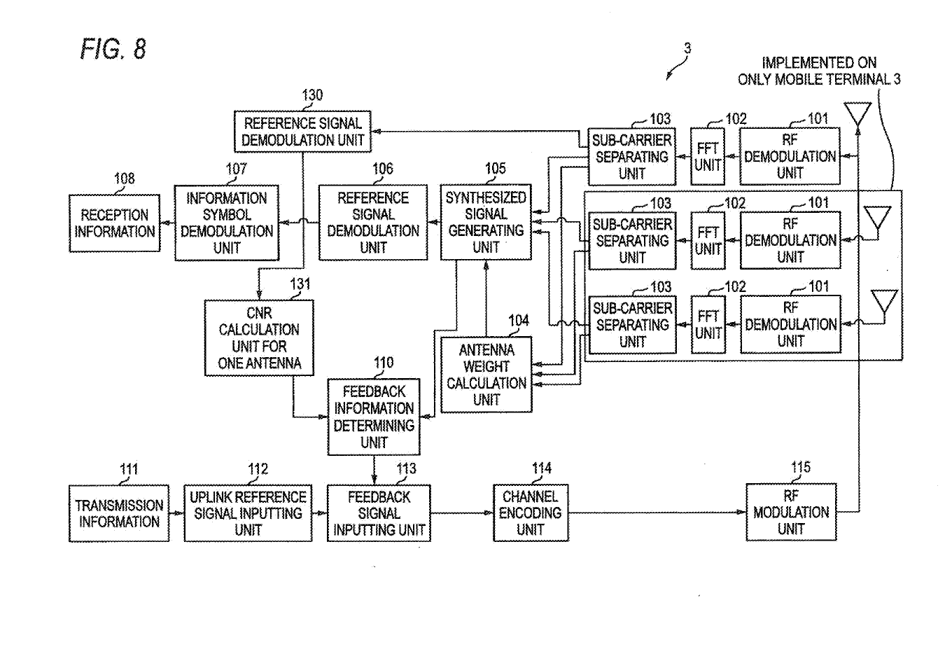

FIG. 8 is a configuration view of a communication unit of a mobile terminal (three antennas) according to the second illustrative embodiment of the invention. In the meantime, the mobile terminal 3 adopts the beam forming multi-antenna reception manner using the MMSE method.

Each RF demodulation unit 101 performs RF-demodulation on a signal received at each antenna, each FFT unit 102 FFT-transforms the RF-demodulated received signal, and each sub-carrier separating unit 103 separates the received signal of sub-carrier.

The antenna weight calculation unit 104 calculates an antenna weight for each antenna by using the MMSE method, for example, based on the received signal of sub-carrier of each sub-carrier separating unit 103. The synthesized signal generating unit 105 generates a synthesized signal from the received signals of sub-carriers, based on the received signal of sub-carrier of each sub-carrier separating unit 103 and the antenna weight for each antenna.

The reference signal demodulation unit 106 demodulates a downlink reference signal from the synthesized signal, and the information symbol demodulation unit 107 demodulates an information symbol from the synthesized signal. The demodulated symbol becomes reception information 108.

A reference signal demodulation unit 130 demodulates the downlink reference signal from the one sub-carrier separating unit 103. A CNR calculation unit 131 compares the downlink reference signal demodulated in the reference signal demodulation unit 130 and a known signal to thus obtain a CNR (Carrier to Noise Ratio) value as a value of the S/N ratio.

The feedback information determining unit 110 determines reception quality information to be carried on a feedback signal.

The uplink reference signal inputting unit 112 inputs a known signal as the reference signal to transmission information 111. The feedback signal inputting unit 113 inputs the CNR, which is obtained in previous reception, as the reception quality information to be carried on a feedback signal.

The channel encoding unit 114 encodes the feedback signal and the information symbol, and the RF modulation unit 115 performs RF-modulation on the encoded transmission signal and transmits the same at timing of prescribed time slot through the antenna.

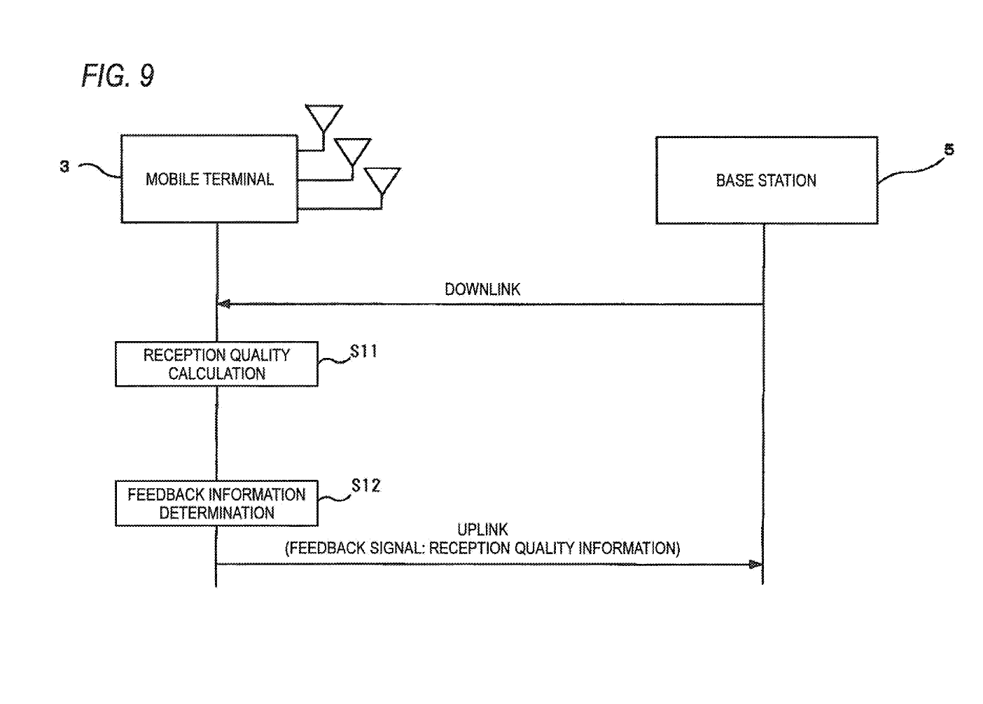

FIG. 9 shows a part of an operation of a wireless communication system according to the second illustrative embodiment of the invention.

The mobile terminal 3 receives a signal (downlink) transmitted from the base station 5, demodulates the downlink reference signal from the one sub-carrier separating unit 103 and calculates a reception quality based on the demodulated downlink reference signal and a known signal (S11).

The feedback information determining unit 110 outputs the reception quality information (feedback information) to be carried on a feedback signal (S12).

The transmission power determining unit 514 of the base station 5 compares the reception quality information included in the four feedback signals corresponding to each time slot, and determines a transmission signal level for next sub-carrier. At this time, the transmission power determining unit 514 controls so that the transmission level is lowered when the reception quality is better than the others and the transmission level is increased if the level does not reach an upper limit, when the reception quality is poorer, thereby adjusting an overall balance.

Here, the mobile terminal 3 configures the antenna array by using the three antennas, thereby improving the reception performance. However, the mobile terminal uses the signal received from the one antenna for calculation of the CNR value. Therefore, the CNR value is expected to be deteriorated, as compared to the received signal synthesized by the weights for each antenna by using the three antennas. That is, the reception quality information equivalent to the mobile terminal having the one antenna is fed back. As a result, the base station 5 does not suppress the transmission power so that it is low in conformity to the feedback information from the mobile terminal 3 having the multiple antennas conformed to the improved portion of the reception performance. Therefore, the mobile terminal 3 can exhibit the performance in conformity to the reception performance.

### Third Illustrative Embodiment of the Invention

By the way, in the mobile terminal 3, when the CNR value is somewhat large, if it is reported that the reception quality information, which is fed back to the base station, is as low as the improved portion of the reception performance, it is possible to secure the improved portion of the reception performance as a margin because there is no case where the transmission power of the base station becomes low beyond expectation. However, as the CNR value is lowered, if it is reported that the reception quality information, which is fed back to the base station, is as low as the improved portion of the reception performance, the base station determines that the communication is impossible, which cannot contribute to the increase in coverage. Therefore, following measures are taken.

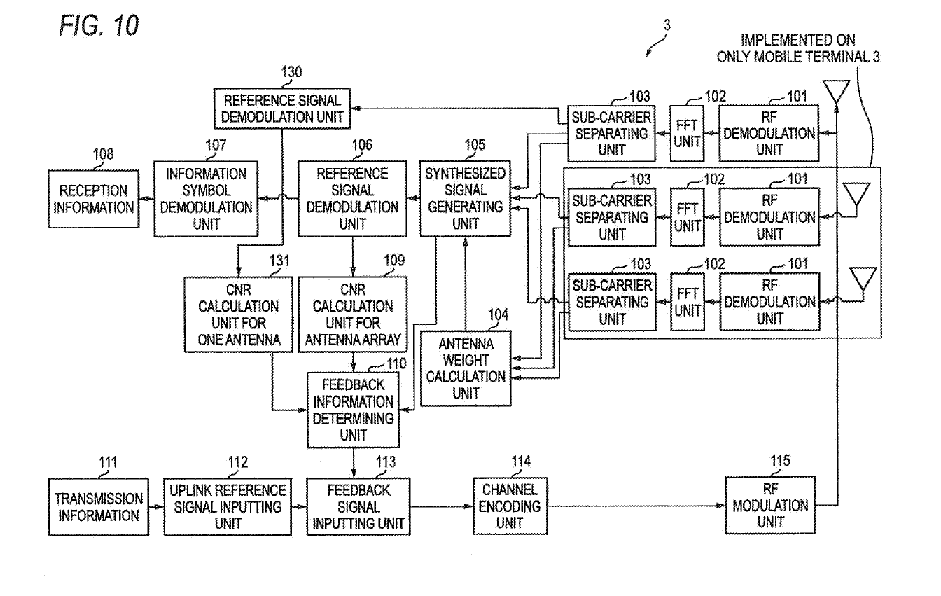

FIG. 10 is a configuration view of a communication unit of a mobile terminal (three antennas) according to a third illustrative embodiment of the invention. The same configurations as those of the mobile terminal shown in FIG. 8 are denoted with the same reference numerals, and the descriptions thereof are omitted.

The CNR calculation unit 109 compares the downlink reference signal and the known signal to thus obtain a CNR (Carrier to Noise Ratio) as a value of the S/N ratio. In the meantime, the downlink reference signal is also used for frame synchronization of the base station 5 and the mobile terminal.

The feedback information determining unit 110 sets the reception quality information, which is carried on a feedback signal, to be the CNR value of the CNR calculation unit 109 when the CNR value of the CNR calculation unit 131 is a threshold or smaller.

The uplink reference signal inputting unit 112 inputs a known signal as the reference signal to the transmission information 111. The feedback signal inputting unit 113 inputs the CNR, which is obtained in previous reception, as the reception quality information to be carried on a feedback signal.

The channel encoding unit 114 encodes the feedback signal and the information symbol, and the RF modulation unit 115 performs RF-modulation on the encoded transmission signal and transmits the same at timing of prescribed time slot through the antenna.

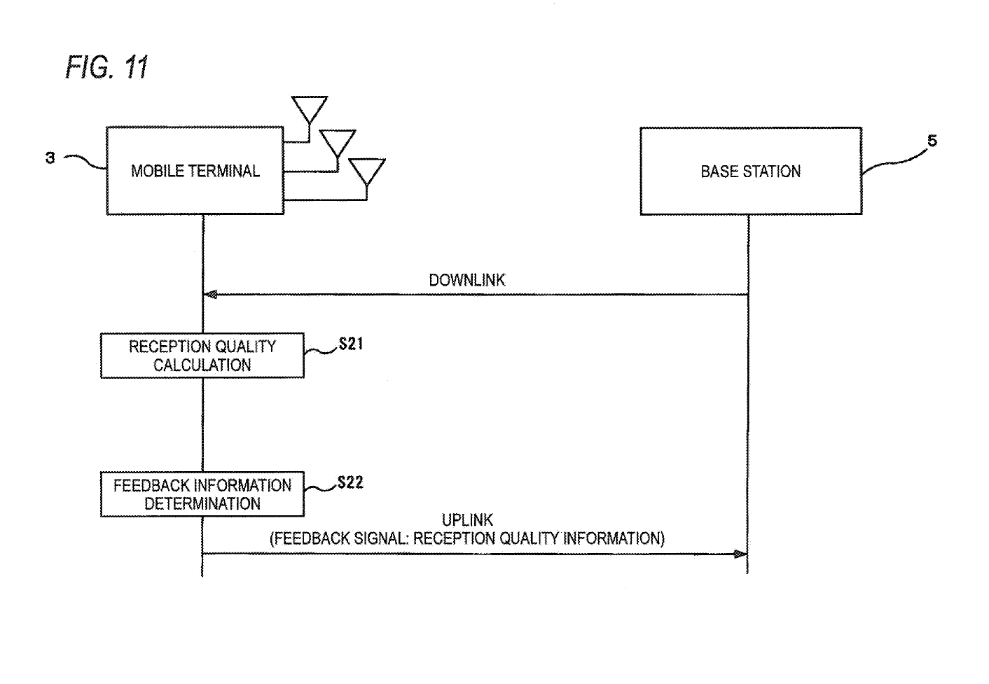

FIG. 11 shows a part of an operation of the wireless communication system.

The mobile terminal 3 receives a signal (downlink) transmitted from the base station 5, calculates a reception quality based on the known signal and the signal received from the one antenna and obtains reception qualities based on known signals and synthesized signals obtained from the signals received from the three antennas by the antenna array reception method (S21).

When the reception quality obtained from the one antenna is a predetermined threshold or lower, the feedback information determining unit 110 outputs as the reception quality information (feedback information) obtained by the three antennas and the antenna array reception method (S32).

The transmission power determining unit 514 of the base station 5 compares the reception quality information included in the four feedback signals corresponding to each time slot, and determines a transmission signal level for next sub-carrier. At this time, the transmission power determining unit 514 controls so that the transmission level is lowered when the reception quality is better than the others and the transmission level is increased if the level does not reach an upper limit, when the reception quality is poorer, thereby adjusting an overall balance.

As described above, when the reception quality obtained from the one antenna is a predetermined threshold or lower, the feedback information is configured by using the reception qualities obtained by the three antennas and the antenna array reception method. Thereby, even when the mobile terminal is far away from the base station 5, it is possible to increase the coverage by the improved portion of the reception performance.

In the above example, the mobile terminal 1, the mobile terminal 2 and the mobile terminal 4 has one antenna, and the mobile terminal 3 adopts the beam forming multi-antenna reception manner using the MMSE method. However, the invention can be also applied to a configuration where the mobile terminal 1, the mobile terminal 2 and the mobile terminal 4 adopt the beam forming multi-antenna reception manner and the other beam forming method such as the maximum ratio combining method, the MMSE method, the SIC method, the MLD method and the like is adopted.

Although the invention has been specifically described with reference to the specific illustrative embodiments, it is apparent to one skilled in the art that a variety of changes or modifications can be made without departing from the spirit and scope of the invention.

The present application is based on the Japanese Patent Application Nos. 2011-271917 and 2011-271918 filed on Dec. 13, 2011, the contents thereof being here incorporated for reference.

### DESCRIPTION OF THE REFERENCE NUMERALS

1 to 4: mobile terminal
5: base station
101: each RF demodulation unit
102: each FFT unit
103: each sub-carrier separating unit
104: antenna weight calculation unit
105: synthesized signal generating unit
106, 130: reference signal demodulation unit
107: information symbol demodulation unit
108: reception information
109, 131: CNR calculation unit
110: feedback information determining unit
111: transmission information
112: uplink reference signal inputting unit
113: feedback signal inputting unit
114: channel encoding unit
115: RF modulation unit
120: offset value determining unit
501: input signal
502: downlink reference signal inputting unit
503: each channel encoding unit
505: multiplexing unit
506: IFFT
507: RF modulation unit
508: RF demodulation unit
509: timing separating unit
511: each feedback signal demodulation unit
512: each channel decoding unit
513: output signal
514: transmission power determining unit

What is claimed is:

1. A mobile terminal that transmits a feedback signal when performing transmission power control with a base station, the mobile terminal comprising:
a plurality of antennas;
a calculation unit that calculates a reception quality based on a known signal and a signal received from at least one of the multiple antennas; and
a feedback information determining unit that determines feedback information based on the reception quality,
wherein the mobile terminal transmits a feedback signal based on the feedback information to the base station.

2. The mobile terminal according to claim 1,
wherein the calculation unit obtains the reception quality, based on the known signal and a synthesized signal obtained by an antenna array reception method of the respective signals received from the multiple antennas, and
wherein the feedback information determining unit determines the feedback information, based on the reception quality and an offset value.

3. The mobile terminal according to claim 2, further comprising
an offset value determining unit that determines the offset value, depending on the reception quality.

4. The mobile terminal according to claim 2, further comprising
an offset value determining unit that determines the offset value for each multi-antenna reception method.

5. The mobile terminal according to claim 1,
wherein the calculation unit obtains the reception quality, based on the one received signal of the multiple antennas and the known signal.

6. The mobile terminal according to claim 1, further comprising
a separate calculation unit that obtains a synthesized signal reception quality, based on the known signal and a synthesized signal obtained from the signals received from the respective antennas by an antenna array reception method, and
wherein the feedback information determining unit determines the synthesized signal reception quality as the feedback information when the reception quality is a predetermined threshold or lower.

7. A mobile terminal that transmits a feedback signal when performing transmission power control with a base station, the mobile terminal comprising:
a storage unit that stores a instruction set, and
a controller,
wherein the controller executes the instruction set to:
obtain a reception quality based on a known signal and a signal received from at least one of the multiple antennas;
determine feedback information based on the reception quality; and
transmit a feedback signal based on the feedback information to the base station.

8. The mobile terminal according to claim 7,
wherein the controller executes the instruction set to
obtain the reception quality, based on the known signal and a synthesized signal obtained by an antenna array reception method of the respective signals received from the multiple antennas, and
determining the feedback information, based on the reception quality and an offset value.

9. The mobile terminal according to claim 7,
wherein the controller executes the instruction set to:
obtain the reception quality, based on the one received signal of the multiple antennas and the known signal.

10. A wireless communication method of a mobile terminal that transmits a feedback signal when performing transmission power control with a base station, the wireless communication method comprising the steps of:
obtaining a reception quality based on a known signal and a signal received from at least one of a plurality of antennas;
determining feedback information based on the reception quality; and
transmitting a feedback signal based on the feedback information to the base station.

11. The wireless communication method according to claim 10, further comprising the steps of:
obtaining the reception quality, based on the known signal and a synthesized signal obtained by an antenna array reception method of the respective signals received from the multiple antennas, and
determining the feedback information, based on the reception quality and an offset value.

12. The wireless communication method according to claim 10, further comprising the step of:
obtaining the reception quality, based on the one received signal of the multiple antennas and the known signal.
